(19) United States
(12) Patent Application Publication
(10) Pub. No.: US 2012/0236470 A1
(43) Pub. Date: Sep. 20, 2012

(54) ELECTROLYTIC CAPACITOR

(75) Inventor: Hideki Ishida, Takasago-shi (JP)

(73) Assignee: SANYO ELECTRIC CO., LTD., Moriguchi-shi, Osaka (JP)

(21) Appl. No.: 13/498,500

(22) PCT Filed: Sep. 27, 2010
(86) PCT No.: PCT/JP2010/066652

§ 371 Date: Jun. 6, 2012

(30) Foreign Application Priority Data
Sep. 30, 2009 (JP) 2009-226911

(51) Int. Cl. H01G 9/048

(52) U.S. Cl. 361/531

(57) ABSTRACT

An electrolytic capacitor comprises a wound body including a wound anode foil with a surface on which a dielectric layer is formed, a solid electrolyte layer formed on a surface of the dielectric layer, a cathode layer formed on a surface of the solid electrolyte layer over the outer circumference of the wound body, a plurality of anode leads electrically connected to the anode foil, and a plurality of cathode leads provided in one-to-one relationship with the anode leads and electrically connected to the cathode layer. The edge surface is a part of the surface of the wound body and crosses the winding axis of the wound body. Each of the cathode leads is electrically connected to an outer circumference of the cathode layer at a position near an anode lead corresponding to this cathode lead.

### TECHNICAL FIELD

The present invention relates to an electrolytic capacitor, and more specifically, to a wound electrolytic capacitor.

### BACKGROUND ART

A conventional wound electrolytic capacitor has a wound body formed by placing an anode foil and a cathode foil one above the other, and winding the anode and cathode foils. A dielectric layer is formed on a surface of the anode foil, and a separator saturated with an electrolytic solution is placed between the dielectric layer on the anode foil and the cathode foil. An anode lead is electrically connected to the anode foil, and a cathode lead is electrically connected to the cathode foil (see patent literature 1, for example).

In this electrolytic capacitor, both a position of electrical connection between the anode lead and the anode foil and a position of electrical connection between the cathode lead and the cathode foil can be arranged near the winding axis of the wound body, thereby shortening a distance between the leads. Shortening a distance between the leads reduces a loop inductance generated between the anode and cathode leads, thereby reducing the equivalent series inductance of the electrolytic capacitor.

### CITATION LIST

Patent Literature

Patent literature 1: Japanese Patent Application Laid-Open No. 2007-142353

### SUMMARY OF INVENTION

### Problems to be Solved by the Invention

However, arranging the aforementioned positions of connection near the winding axis of the wound body increases a distance from the outer circumference of the electrolytic capacitor to the anode or cathode lead. So, even if the electrolytic capacitor is mounted on a circuit board at a position near a load circuit such as a CPU (central processing unit), each of the anode and cathode leads of the electrolytic capacitor is separated from the load circuit at least by a distance from the outer circumference of the electrolytic capacitor. This makes an interconnect line for connecting the anode or cathode lead to the load circuit longer, resulting in a problem of increase of an equivalent series inductance generated in the interconnect line.

So, it is an object of the present invention to provide an electrolytic capacitor element with a low equivalent series inductance capable of placing a cathode lead near a load circuit when the electrolytic capacitor element is mounted on a circuit board.

### MEANS FOR SOLVING PROBLEMS

A first electrolytic capacitor of the present invention includes: a wound body including a wound anode foil with a surface on which a dielectric layer is formed; an electrolyte layer formed inside the wound body and over the outer circumference of the wound body; a cathode layer formed on a surface of the electrolyte layer over the outer circumference of the wound body; a plurality of anode leads electrically connected to the anode foil; and a plurality of cathode leads provided in one-to-one relationship with the anode leads and electrically connected to the cathode layer. Each of the anode leads is pulled out through an edge surface of the wound body. Each of the cathode leads is electrically connected to the outer circumference of the cathode layer at a position near an anode lead corresponding to this cathode lead.

In the aforementioned electrolytic capacitor, a distance between each of the cathode leads and an anode lead corresponding to this cathode lead is short, and each of the cathode leads is electrically connected to the outer circumference of the cathode layer at a position near an anode lead corresponding to this cathode lead. This makes a loop inductance low generated between the anode lead and the cathode lead, thereby making the equivalent series inductance (ESL) of the electrolytic capacitor low.

In the aforementioned electrolytic capacitor, each of the anode leads is pulled out through an outer circumferential section of the edge surface of the wound body. This makes it possible to place each of the cathode leads at a position near the outer circumference of the electrolytic capacitor, or at a position in the same plane as the outer circumference of the electrolytic capacitor without involving increase of a distance between each of the cathode leads and an anode lead corresponding to this cathode lead. Thus, according to this structure, the cathode leads can be placed near a load circuit when the electrolytic capacitor is mounted on a circuit board. Placing the cathode leads near the load circuit shortens an interconnect distance between the cathode leads and the load circuit, resulting in reduction of an equivalent series inductance (ESL) generated between the electrolytic capacitor and the load circuit.

Further, in the aforementioned electrolytic capacitor, a capacitor component is formed between each of the cathode leads and an anode lead corresponding to this cathode lead. The number of the capacitor components corresponds to the number of the anode leads provided in the electrolytic capacitor, and the capacitor components are connected in parallel. In consideration of an equivalent series inductance (ESL) and an equivalent series resistance (ESR) generated between each of the cathode leads and an anode lead corresponding to this cathode lead, a capacitor component, an ESL, and an ESR form a series circuit in the electrolytic capacitor. So, the electrolytic capacitor is given an equivalent circuit in which the number of the series circuits corresponds to the number of the anode leads, and the series circuits are connected in parallel. As a result, the electrostatic capacitance of the electrolytic capacitor increases in proportion to the number of the anode leads, and at the same time, the ESL and the ELR of the electrolytic capacitor are reduced in inverse proportion to the number of the anode leads.

In a specific structure of the first electrolytic capacitor, the wound body is formed by winding a plurality of the anode foils, and the anode leads are electrically connected to each of the anode foils at one or a plurality of positions.

In another specific structure of the first electrolytic capacitor, the wound body is formed by winding only one anode foil, and the anode leads are electrically connected to the anode foil at a plurality of positions.

In still another specific structure of the first electrolytic capacitor, the electrolytic capacitor further includes a bottomed cylindrical conductive case housing the wound body. Conducting part of the conductive case is exposed at least at the inner circumference thereof. A conductive member electrically connecting the conducting part of the conductive case and the cathode layer is placed between the inner circumference of the conductive case and the outer circumference of the cathode layer at least at a position near each of the anode leads. The cathode leads are connected to the conducting part of the conductive case to be electrically connected to the outer circumference of the cathode layer through the conductive case and the conductive member.

This specific structure allows the outer circumference of the conductive case to form the outer circumference of the electrolytic capacitor. In this structure, the cathode leads are placed at positions near the outer circumference of the conductive case functioning as the outer circumference of the electrolytic capacitor, or at positions in the same plane as the outer circumference of the conductive case.

A second electrolytic capacitor of the present invention includes a plurality of wound elements, a bottomed cylindrical conductive case housing the wound elements, and a plurality of cathode leads provided in one-to-one relationship with the wound elements and electrically connected to conducting part of the conductive case. Each of the wound elements has a wound body including a wound anode foil with a surface on which a dielectric layer is formed, an electrolyte layer formed inside the wound body and over the outer circumference of the wound body, a cathode layer formed on a surface of the electrolyte layer over the outer circumference of the wound body, and an anode lead electrically connected to the anode foil and pulled out through an edge surface of the wound body.

Each of the wound elements is arranged near the inner circumference of the conductive case, and each of the cathode leads is placed at a position near a wound element corresponding to this cathode lead. Further, the conducting part of the conductive case is exposed at least at the inner circumference of the conductive case. A conductive member electrically connecting the conducting part of the conductive case and the cathode layer is placed between the inner circumference of the conductive case and the outer circumference of the cathode layer of each of the wound elements at least at a position near the anode lead of this wound element.

In the aforementioned electrolytic capacitor, a distance between each of the cathode leads and the anode lead of a wound element corresponding to this cathode lead is short. Further, the conductive member is placed between the inner circumference of the conductive case and the outer circumference of the cathode layer of each of the wound elements at least at a position near the anode lead of this wound element. Thus, each of the cathode leads is electrically connected to the outer circumference of the cathode layer of a wound element corresponding to this cathode lead at a position near the anode lead of this wound element. This makes a loop inductance low generated between the anode lead and the cathode lead, thereby making the equivalent series inductance (ESL) of the electrolytic capacitor low.

Also, in the aforementioned electrolytic capacitor, each of the cathode leads is connected to the conducting part of the conductive case. Further, the outer circumference of the conductive case is capable of forming the outer circumference of the electrolytic capacitor. This structure places each of the cathode leads at a position near the outer circumference of the electrolytic capacitor, or at a position in the same plane as the outer circumference of the conductive case. Thus, the cathode leads can be placed near a load circuit when the electrolytic capacitor is mounted on a circuit board. Placing the cathode leads near the load circuit shortens an interconnect distance between the cathode leads and the load circuit, resulting in reduction of an equivalent series inductance (ESL) generated between the electrolytic capacitor and the load circuit.

Further, in the aforementioned electrolytic capacitor, a capacitor component is formed between each of the cathode leads and the anode lead of a wound element corresponding to this cathode lead. The number of the capacitor components corresponds to the number of the wound elements provided in the electrolytic capacitor, and the capacitor components are connected in parallel. In consideration of an equivalent series inductance (ESL) and an equivalent series resistance (ESR) generated between each of the cathode leads and the anode lead of a wound element corresponding to this cathode lead, a capacitor component, an ESL, and an ESR form a series circuit in the electrolytic capacitor. So, the electrolytic capacitor is given an equivalent circuit in which the number of the series circuits corresponds to the number of the wound elements, and the series circuits are connected in parallel. As a result, the electrostatic capacitance of the electrolytic capacitor increases in proportion to the number of the wound elements, and at the same time, the ESL and the ELR of the electrolytic capacitor are reduced in inverse proportion to the number of the wound elements.

In a specific structure of each of the first and second capacitors, the conducting part of the conductive case and the cathode leads are integrally formed.

### EFFECT OF THE INVENTION

The electrolytic capacitor of the present invention has a low equivalent series inductance, and is capable of placing a cathode lead near a load circuit when the electrolytic capacitor is mounted on a circuit board.

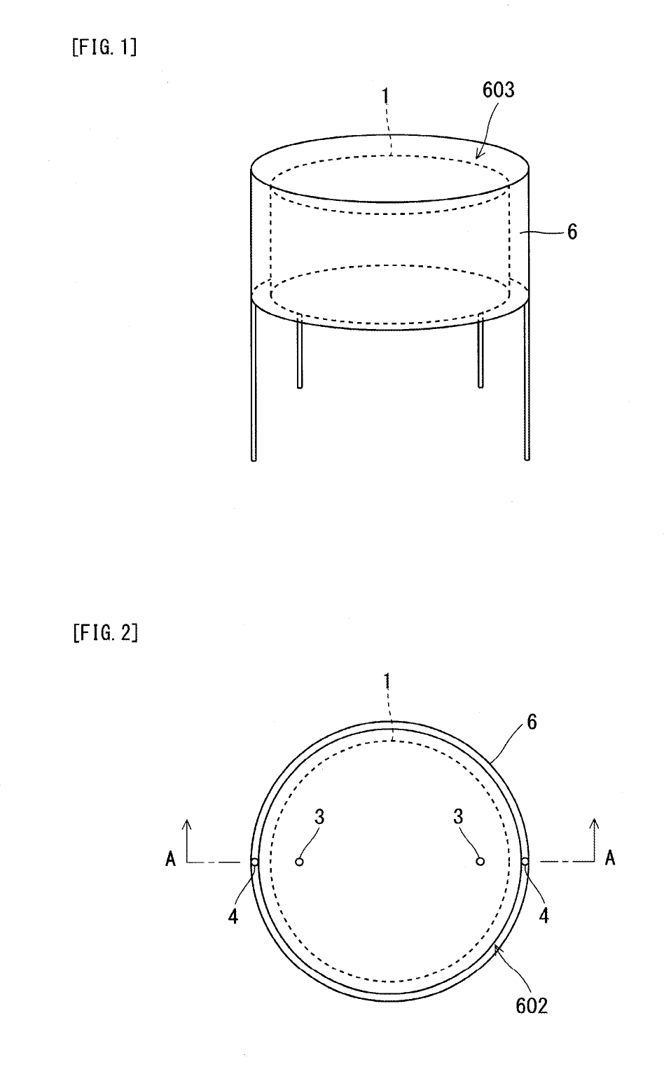

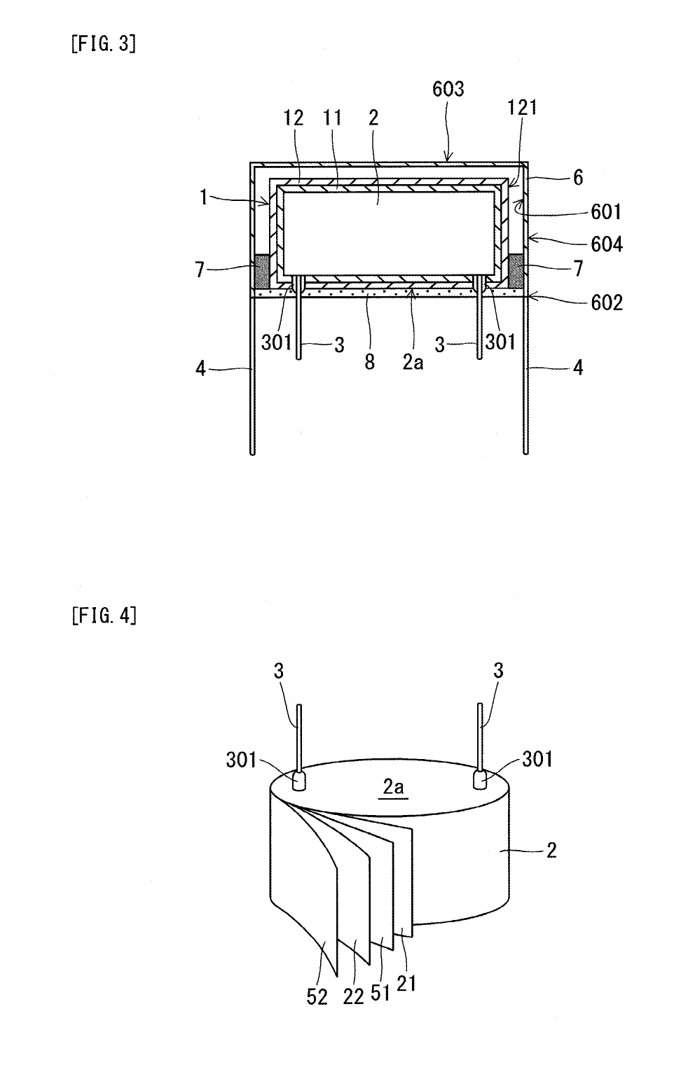

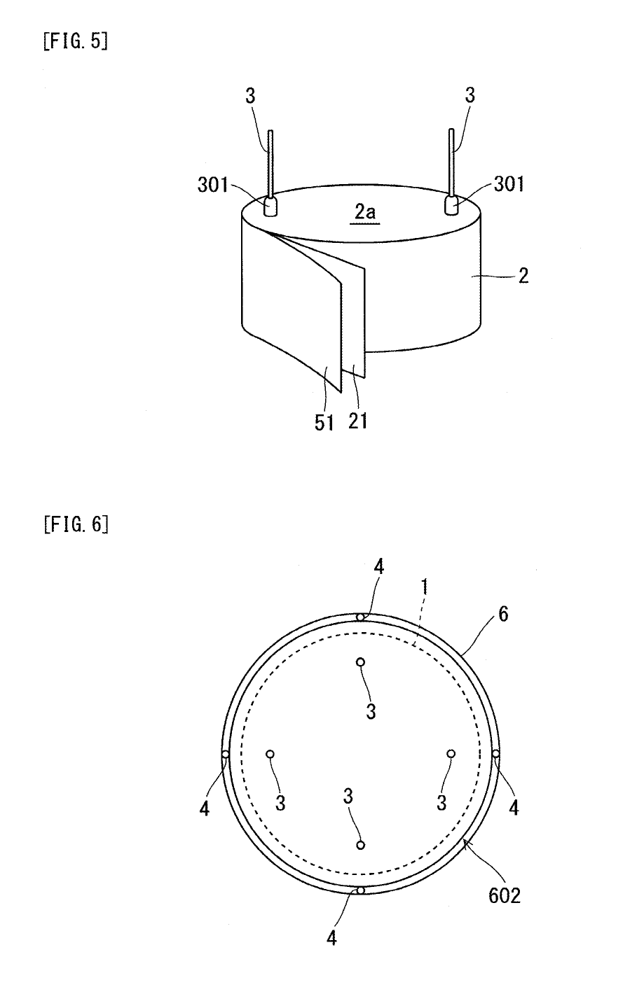

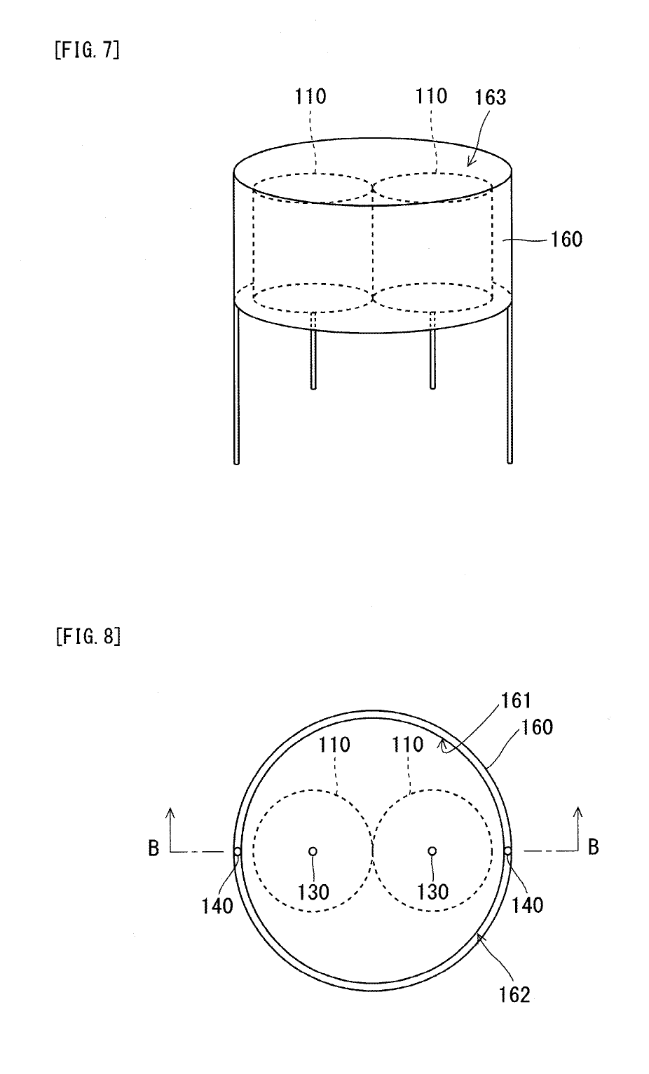

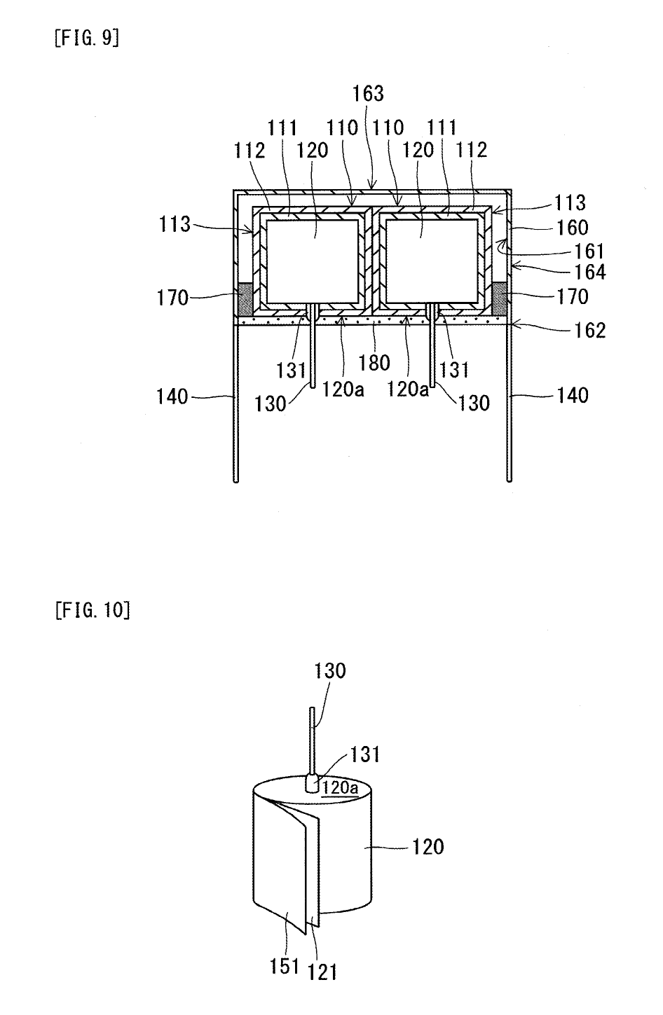

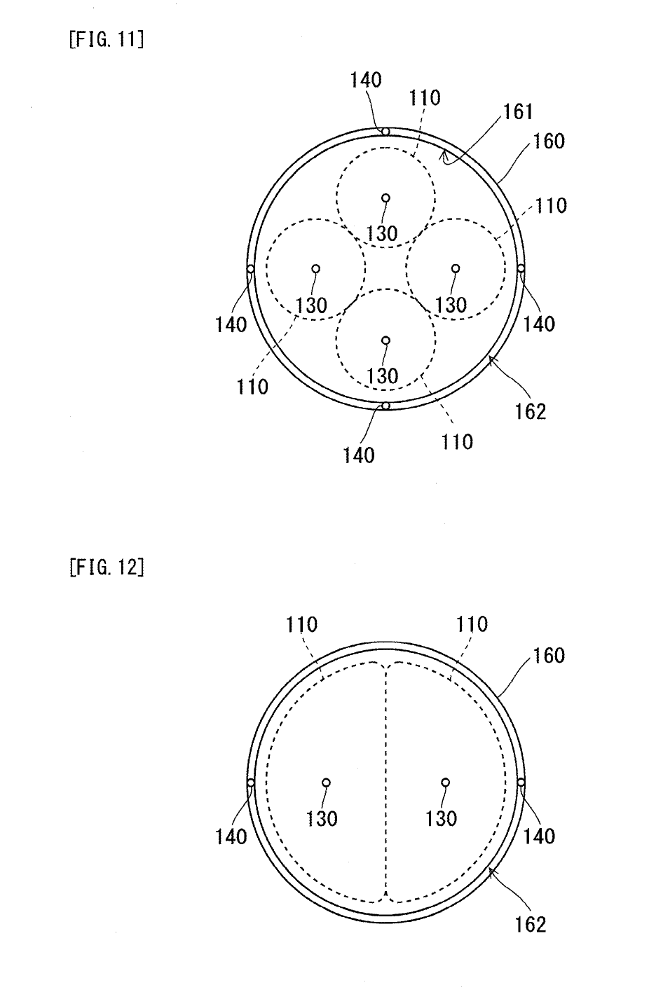

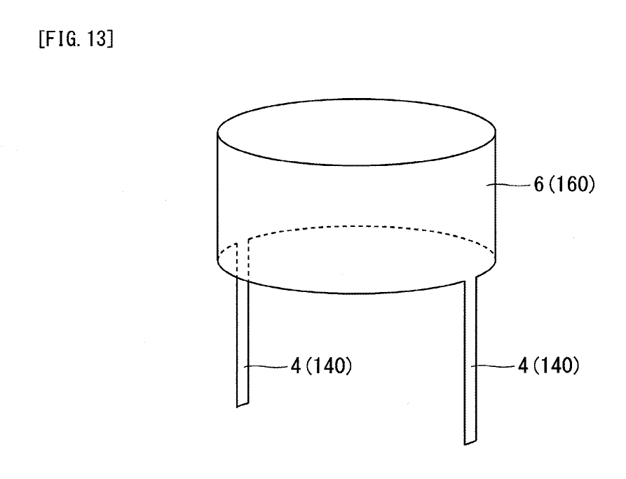

### BRIEF DESCRIPTION OF DRAWINGS

[FIG. 1] FIG. 1 is a perspective view showing an electrolytic capacitor of a first embodiment of the present invention.

[FIG. 2] FIG. 2 is a plan view of the electrolytic capacitor of the first embodiment as viewed from a side opposite a bottom wall of a metal case provided in the electrolytic capacitor.

[FIG. 3] FIG. 3 is a sectional view taken along line A-A shown in FIG. 2.

[FIG. 4] FIG. 4 is a perspective view showing a wound body of a wound element provided in the electrolytic capacitor of the first embodiment.

[FIG. 5] FIG. 5 is a perspective view showing a modification of the wound body of the electrolytic capacitor of the first embodiment.

[FIG. 6] FIG. 6 is a plan view showing a modification of the electrolytic capacitor of the first embodiment as viewed from a side opposite the bottom wall of the metal case.

[FIG. 7] FIG. 7 is a perspective view showing an electrolytic capacitor of a second embodiment of the present invention.

[FIG. 8] FIG. 8 is a plan view of the electrolytic capacitor of the second embodiment as viewed from a side opposite a bottom wall of a metal case provided in the electrolytic capacitor.

[FIG. 9] FIG. 9 is a sectional view taken along line B-B shown in FIG. 8.

[FIG. 10] FIG. 10 is a perspective view showing a wound body of a wound element provided in the electrolytic capacitor of the second embodiment.

[FIG. 11] FIG. 11 is a plan view showing a first modification of the electrolytic capacitor of the second embodiment as viewed from a side opposite the bottom wall of the metal case.

[FIG. 12] FIG. 12 is a plan view showing a second modification of the electrolytic capacitor of the second embodiment as viewed from a side opposite the bottom wall of the metal case.

[FIG. 13] FIG. 13 is a perspective view showing a metal case applicable to the electrolytic capacitors of the first and second embodiments.

### EMBODIMENTS FOR CARRYING OUT INVENTION

Embodiments of the present invention are described in detail by referring to the drawings.

### First Embodiment

FIG. 1 is a perspective view showing an electrolytic capacitor of a first embodiment of the present invention. As shown in FIG. 1, the electrolytic capacitor of the present embodiment includes a wound element (1), and a bottomed cylindrical metal case (6) housing the wound element (1).

FIG. 2 is a plan view of the electrolytic capacitor as viewed from a side opposite a bottom wall (603) of the metal case (6). FIG. 3 is a sectional view taken along line A-A shown in FIG. 2. As shown in FIG. 3, the wound element (1) includes a wound body (2), and a pair of anode leads (3).

FIG. 4 is a perspective view showing the wound body (2). As shown in FIG. 4, the wound body (2) is formed by placing two long-length anode foils (21) and (22) one above the other, and winding the anode foils (21) and (22). The anode foils (21) and (22) are made of a valve acting metal such as aluminum. Surfaces of the anode foils (21) and (22) are given fine recesses and projections formed as a result of etching process. So, the anode foils (21) and (22) both have wide surface areas.

The surfaces of the anode foils (21) and (22) are also provided with an oxide coating film formed as a result of chemical conversion process. This means that a dielectric layer made of the oxide coating film is formed on the surfaces of the anode foils (21) and (22). So, part of the dielectric layer formed on the surfaces of the anode foils (21) and (22) is exposed at a surface of the wound body (2).

As shown in FIG. 4, when the wound body (2) is formed in the present embodiment, a separator (51) made of craft paper or the like is inserted between the two anode foils (21) and (22), and a different separator (52) is provided to overlap a surface of the anode foil (22) opposite to the surface thereof on which the separator (51) is provided. Then, they are wound while the anode foil (21) is placed at the innermost side. So, in the wound body (2) thereby formed, each of the two separators (51) and (52) is placed between the two anode foils (21) and (22).

In the wound element (1), a solid electrolyte layer (11) is formed inside the anode foils (21) and (22) and over the outer circumferences of the anode foils (21) and (22). The solid electrolyte layer (11) may be formed of materials such as an inorganic semiconductor, an organic semiconductor, and a conductive polymer. In FIG. 3, only part of the solid electrolyte layer (11) is shown that covers the dielectric layer exposed at the surface of the wound body (2).

In order to form the solid electrolyte layer (11) by using a conductive polymer, the wound body (2) is dipped into a polymerization solution, and then chemical polymerization is generated. Dipping the wound body (2) in the polymerization solution makes the polymerization solution penetrate the two separators (51) and (52). Thus, the solid electrolyte layer (11) is easy to be form on specific part of the dielectric layer. The specific part is formed on part of the surfaces of the anode foils (21) and (22) that overlaps the two separators (51) and (52).

The solid electrolyte layer (11) may also be formed by dipping the wound body (2) into a polymerization solution, and then generating electropolymerization.

As shown in FIG. 3, a cathode layer (12) is formed on a surface of the aforementioned part of the solid electrolyte layer (11) (part of the solid electrolyte layer (11) that covers the dielectric layer exposed at the surface of the wound body (2)).

Although not shown in FIG. 3, the cathode layer (12) includes a carbon layer formed on the surface of this part of the solid electrolyte layer (11), and a silver paste layer formed on the carbon layer and electrically connected to the carbon layer.

In the wound element (1), the anode leads (3) as a pair are electrically connected to the corresponding ones of the two anode foils (21) and (22). Further, as shown in FIG. 4, each of the anode leads (3) is pulled out through an outer circumferential section of an edge surface (2a) (edge surface formed by winding). The edge surface (2a) is part of the surface of the wound body (2) and crosses the winding axis of the wound body (2). Further, as shown in FIG. 2, the anode leads (3) as a pair are provided at positions exhibiting rotational symmetry of 180 degrees about the wounding axis of the wound body (2). In the present embodiment, the wounding axis of the wound body (2) agrees with the central axis of the electrolytic capacitor.

Each of the anode leads (3) has a pulled-out portion, a root end of which is covered with an insulating member (301). The insulating member (301) prevents electrical short of the anode lead (3) with the solid electrolyte layer (11) and the cathode layer (12).

The metal case (6) is made of a conductive material such as aluminum and copper. Conducting part made of the conductive material is exposed at least at an inner circumference (601) and an opening edge (602) (see FIG. 3). Also, as shown in FIG. 3, an outer circumference (604) of the metal case (6) forms the outer circumference of the electrolytic capacitor. The wound element (1) is housed in the metal case (6) in a position that makes the edge surface (2a) of the wound body (2) face a side of the metal case (6) opposite the bottom wall (603).

A pair of cathode leads (4) is electrically connected to the opening edge (602) of the metal case (6). The outer circumference of each of the cathode leads (4) and the outer circumference (604) of the metal case (6) are aligned in the same plane. The cathode leads (4) as a pair are provided in one-to-one relationship with the anode leads (3).

As shown in FIG. 2, each of the cathode leads (4) is placed at a position on the opening edge (602) that minimizes a distance from this cathode lead (4) to a corresponding anode lead (3). More specifically, the cathode leads (4) as a pair are arranged in a manner that aligns all the cathode leads (4) and all the corresponding anode leads (3) as a pair on the same line A-A shown in FIG. 2. So, like the anode leads (3) as a pair, the cathode leads (4) as a pair are provided at positions exhibiting rotational symmetry of 180 degrees about the central axis of the electrolytic capacitor.

As shown in FIG. 3, a conductive adhesive agent (7) is provided between the inner circumference (601) of the metal case (6) and an outer circumference (121) of the cathode layer (12), and at a position near the opening edge (602). The conductive adhesive agent (7) electrically connects the conducting part of the metal case (6) and the cathode layer (12).

So, the cathode layer (12) of the wound element (1) and the metal case (6) are electrically continuous with each other at a position near each of anode leads (3) through the conductive adhesive agent (7). This electrically connects each of the cathode leads (4) to the outer circumference (121) of the cathode layer (12) through the metal case (6) and the conductive adhesive agent (7) at a position near an anode lead (3) corresponding to this cathode lead (4).

As shown in FIG. 3, an opening of the metal case (6) is sealed with a sealing material (8) made of a resin material, a rubber material, or the like. The pair of anode leads (3) of the wound element (1) is supported by the sealing material (8) by making the tip end portions of the anode leads (3) project outward of a surface of the sealing material (8), thereby fixedly placing the wound element (1) in the metal case (6).

If a rubber material is used as the sealing material (8), the sealing material (8) is inserted into the opening of the metal case (6), and thereafter, an opening edge portion of the metal case (6) is swaged to fix the sealing material (8) to the metal case (6), thereby sealing the opening of the metal case (6).

In the aforementioned electrolytic capacitor, a distance between each of the cathode leads (4) and an anode lead (3) corresponding to this cathode lead (4) is short, and each of the cathode leads (4) is electrically connected to the outer circumference (121) of the cathode layer (12) at a position near an anode lead (3) corresponding to this cathode lead (4). This makes a loop inductance low generated between the anode lead (3) and the cathode lead (4), thereby making the equivalent series inductance (ESL) of the electrolytic capacitor low.

In the aforementioned electrolytic capacitor, the outer circumference of each of the cathode leads (4) and the outer circumference (604) of the metal case (6) are aligned in the same plane. Further, the outer circumference of the metal case (6) forms the outer circumference of the electrolytic capacitor. So, the outer circumference of each of the cathode leads (4) is arranged in the same plane as the outer circumference of the electrolytic capacitor. This makes it possible to place the cathode leads (4) near a load circuit when the electrolytic capacitor is mounted on a circuit board. Placing the cathode leads (4) near the load circuit shortens an interconnect distance between the cathode leads (4) and the load circuit, resulting in reduction of an equivalent series inductance (ESL) generated between the electrolytic capacitor and the load circuit.

Further, in the aforementioned electrolytic capacitor, a capacitor component is formed between each of the cathode leads (4) and an anode lead (3) corresponding to this cathode lead (4). The number of the capacitor components corresponds to the number of the anode leads (3) provided in the electrolytic capacitor, and the capacitor components are connected in parallel. In consideration of an equivalent series inductance (ESL) and an equivalent series resistance (ESR) generated between each of the cathode leads (4) and an anode lead (3) corresponding to this cathode lead (4), a capacitor component, an ESL, and an ESR form a series circuit in the electrolytic capacitor. So, the electrolytic capacitor is given an equivalent circuit in which the number of the series circuits corresponds to the number of the anode leads (3), and the series circuits are connected in parallel. As a result, the electrostatic capacitance of the electrolytic capacitor increases in proportion to the number of the anode leads (3), and at the same time, the ESL and the ELR of the electrolytic capacitor are reduced in inverse proportion to the number of the anode leads (3).

As shown in FIG. 2, in the aforementioned electrolytic capacitor, the anode leads (3) as a pair are provided at positions exhibiting rotational symmetry of 180 degrees about the central axis of the electrolytic capacitor, and further, the cathode leads (4) as a pair are provided at positions exhibiting rotational symmetry of 180 degrees about the central axis of the electrolytic capacitor. So, even if the electrolytic capacitor to be mounted on a circuit board in a predetermined position is placed on the circuit board in a position rotated 180 degrees from the predetermined position about the central axis of the electrolytic capacitor, the electrolytic capacitor is capable of exhibiting certain electric characteristics.

FIG. 5 is a perspective view showing a modification of the wound body (2) of the electrolytic capacitor of the first embodiment. As shown in FIG. 5, the wound body (2) may be formed by winding only one anode foil (21). In this case, the anode leads (3) are electrically connected to the anode foil (21) at two positions. When the wound body (2) of this modification is formed, the separator (51) is placed over one anode foil (21), and thereafter, they are wound while the anode foil (121) is placed at the inner side.

FIG. 6 is a plan view showing a modification of the electrolytic capacitor of the first embodiment as viewed from a side opposite the bottom wall (603) of the metal case (6) (see FIG. 1). As shown in FIG. 6, the electrolytic capacitor may include four anode leads (3) and four cathode leads (4) provided in one-to-one relationship with each other.

Specific structures of the wound body (2) and the anode leads (3) in this case may be such that two anode leads (3) are electrically connected to the anode foil (21) at two positions, and that two anode leads (3) are electrically connected to the anode foil (21) at two positions. Specific structures of the wound body (2) and the anode leads (3) in this case may also be such that the wound body (2) of the wound element (1) is formed by placing four anode foils one above the other and winding the four anode foils, and that the anode leads (3) are electrically connected to corresponding ones of the anode foils only at one position.

The present invention is not limited to the electrolytic capacitor including two anode leads (3) and two cathode leads (4) provided in one-to-one relationship with each other (FIG. 2), or to the electrolytic capacitor including four anode leads (3) and four cathode leads (4) provided in one-to-one relationship with each other (FIG. 4). As an example, the electrolytic capacitor may include three anode leads (3) and three cathode leads (4) provided in one-to-one relationship with each other, or may include five or more anode leads (3) and five or more cathode leads (4) provided in one-to-one relationship with each other.

Specific structures of the wound body (2) and the anode leads (3) in either case may be such that the wound body (2) are formed by placing a plurality of anode foils one above the other and winding the anode foils, and that the anode leads (3) are electrically connected to corresponding ones of the anode foils at one or a plurality of positions. Specific structures of the wound body (2) and the anode leads (3) in either case may also be such that the wound body (2) is formed by winding only one anode foil, and that the anode leads (3) are electrically connected to the anode foil at a plurality of positions.

In the electrolytic capacitor of the first embodiment, the conductive adhesive agent (7) provided between the inner circumference (601) of the metal case (6) and the outer circumference (121) of the cathode layer (12) may not be limited at a position near the opening edge (602), but may extend along the entire outer circumference (121) of the cathode layer (12).

Also, in the electrolytic capacitor of the first embodiment, the pair of cathode leads (4) may be connected to the inner circumference (601) of the metal case (6). In this case, each of the cathode leads (4) is still placed at a position near the outer circumference of the electrolytic capacitor. So, like those of the aforementioned electrolytic capacitor, the cathode leads (4) of the electrolytic capacitor of this case can be placed near a load circuit when this electrolytic capacitor is mounted on a circuit board.

FIG. 13 is a perspective view showing the metal case (6) applicable to the electrolytic capacitor of the first embodiment. As shown in FIG. 13, the pair of cathode leads (4) may be formed integrally with the metal case (6), more specifically, with the conducting part of the metal case (6).

The structure of the electrolytic capacitor of the first embodiment may be modified such that the modified electrolytic capacitor does not include the metal case (6). In this case, each of the cathode leads (4) is electrically connected directly to the outer circumference (121) of the cathode layer (12) at a position near an anode lead (3) corresponding to this cathode lead (4).

### Second Embodiment

FIG. 7 is a perspective view showing an electrolytic capacitor of a second embodiment of the present invention. As shown in FIG. 7, the electrolytic capacitor of the present embodiment includes two wound elements (110), and a bottomed cylindrical metal case (160) housing the two wound elements (110).

FIG. 8 is a plan view of the electrolytic capacitor as viewed from a side opposite a bottom wall (163) of the metal case (160). FIG. 9 is a sectional view taken along line B-B shown in FIG. 8. As shown in FIG. 9, each of the wound element (110) includes a wound body (120) and an anode lead (130).

FIG. 10 is a perspective view showing the wound body (120). As shown in FIG. 10, the wound body (120) is formed by winding one long-length anode foil (121). The anode foil (121) is made of a valve acting metal such as aluminum. A surface of the anode foil (121) is given fine recesses and projections formed as a result of etching process. So, the anode foil (121) has a wide surface area.

The surface of the anode foil (121) is also provided with an oxide coating film formed as a result of chemical conversion process. This means that a dielectric layer made of the oxide coating film is formed on the surface of the anode foil (121). So, part of the dielectric layer formed on the surface of the anode foil (121) is exposed at a surface of the wound body (120).

As shown in FIG. 10, when the wound body (120) is formed in the present embodiment, a separator (151) made of craft paper or the like is placed over the anode foil (121). Then, they are wound while the anode foil (121) is placed at the inner side. So, in the wound body (120) thereby formed, the separator (151) is placed in the wound anode foil (121).

In each of the wound elements (110), a solid electrolyte layer (111) is formed on the dielectric layer that is formed on the surface of the anode foil (121). The solid electrolyte layer (111) may be formed of materials such as an inorganic semiconductor, an organic semiconductor, and a conductive polymer. In FIG. 9, only part of the solid electrolyte layer (111) is shown that covers the dielectric layer exposed at the surface of each of the wound bodies (120).

In order to form the solid electrolyte layer (111) by using a conductive polymer, the wound body (120) is dipped into a polymerization solution, and then chemical polymerization is generated. Dipping the wound body (120) in the polymerization solution makes the polymerization solution penetrate the separator (151). Thus, the solid electrolyte layer (111) is easy to form on specific part of the dielectric layer. The specific part is formed on part of the surface of the anode foil (121) that overlaps the separator (151).

The solid electrolyte layer (111) may also be formed by dipping the wound body (120) into a polymerization solution, and then generating electropolymerization.

As shown in FIG. 9, in each of the wound elements (110), a cathode layer (112) is formed on a surface of the aforementioned part of the solid electrolyte layer (111) (part of the solid electrolyte layer (111) that covers the dielectric layer exposed at the surface of a corresponding wound body (120)). Although not shown in FIG. 9, the cathode layer (112) includes a carbon layer formed on the surface of this part of the solid electrolyte layer (111), and a silver paste layer formed on the carbon layer and electrically connected to the carbon layer.

In each of the wound elements (110), the anode lead (130) is electrically connected to the anode foil (121). Further, as shown in FIG. 10, the anode lead (130) is pulled out through a central portion of an edge surface (120a) (edge surface formed by winding). The edge surface (120a) is part of the surface of the wound body (120) and crosses the winding axis of the wound body (120).

The anode lead (130) has a pulled-out portion, a root end of which is covered with an insulating member (131). The insulating member (131) prevents electrical short of the anode lead (130) with the solid electrolyte layer (111) and the cathode layer (112).

The metal case (160) is made of a conductive material such as aluminum and copper. Conducting part made of the conductive material is exposed at least at an inner circumference (161) and an opening edge (162) (see FIG. 9). Also, as shown in FIG. 9, an outer circumference (164) of the metal case (160) forms the outer circumference of the electrolytic capacitor. The two wound elements (110) are housed in the metal case (160) in a position that makes the edge surface (120a) of each of the wound bodies (120) face a side of the metal case (160) opposite the bottom wall (163).

As shown in FIG. 8, the two wound elements (110) are arranged in the metal case (160) such that the respective anode leads (130) of the wound elements (110) are provided at positions exhibiting rotational symmetry of 180 degrees about the central axis of the electrolytic capacitor. In this way, the two wound elements (110) are placed near the inner circumference (161) of the metal case (160).

A pair of cathode leads (140) is electrically connected to the opening edge (162) of the metal case (160). The outer circumference of each of the cathode leads (140) and the outer circumference (164) of the metal case (160) are aligned in the same plane. The cathode leads (140) as a pair are provided in one-to-one relationship with the wound elements (110).

As shown in FIG. 8, each of the cathode leads (140) is placed at a position on the opening edge (162) that minimizes a distance from this cathode lead (140) to the anode lead (130) of a corresponding wound element (110). More specifically, the cathode leads (140) as a pair are arranged in a manner that aligns all the cathode leads (140) and all the anode leads (130) of the two wound elements (130) on the same line B-B shown in FIG. 8. So, like the anode leads (130) as a pair, the cathode leads (140) as a pair are provided at positions exhibiting rotational symmetry of 180 degrees about the central axis of the electrolytic capacitor.

As shown in FIG. 9, a conductive adhesive agent (170) is provided between the inner circumference (161) of the metal case (160) and an outer circumference (113) of the cathode layer (112) of each of the wound elements (110), and at a position near the opening edge (162). The conductive adhesive agent (170) electrically connects the conducting part of the metal case (160) and the cathode layer (112).

So, the cathode layer (112) of each of the wound elements (110) and the metal case (160) are electrically continuous with each other at a position near the anode lead (130) of this wound element (110) through the conductive adhesive agent (170). This electrically connects each of the cathode leads (140) to the outer circumference (113) of the cathode layer (112) of a wound element (110) corresponding to this cathode lead (140) through the metal case (160) and the conductive adhesive agent (170) at a position near the anode lead (130) of this wound element (110).

As shown in FIG. 9, an opening of the metal case (160) is sealed with a sealing material (180) made of a resin material, a rubber material, or the like. The anode lead (130) of each of the wound elements (110) is supported by the sealing material (180) by making the tip end portion of the anode lead (130) project outward of a surface of the sealing material (180), thereby fixedly placing each of the wound elements (110) at a predetermined position in the metal case (160).

If a rubber material is used as the sealing material (180), the sealing material (180) is inserted into the opening of the metal case (160), and thereafter, an opening edge portion of the metal case (160) is swaged to fix the sealing material (180) to the metal case (160), thereby sealing the opening of the metal case (160).

In the aforementioned electrolytic capacitor, a distance between each of the cathode leads (140) and the anode lead (130) of a wound element (110) corresponding to this cathode lead (140) is short. Further, each of the cathode leads (140) is electrically connected to the outer circumference (113) of the cathode layer (112) of a wound element (110) corresponding to this cathode lead (140) at a position near the anode lead (130) of this wound element (110). This makes a loop inductance low generated between the anode lead (130) and the cathode lead (140), thereby making the equivalent series inductance (ESL) of the electrolytic capacitor low.

In the aforementioned electrolytic capacitor, the outer circumference of each of the cathode leads (140) and the outer circumference (164) of the metal case (160) are aligned in the same plane. Further, the outer circumference of the metal case (160) forms the outer circumference of the electrolytic capacitor. So, the outer circumference of each of the cathode leads (140) is arranged in the same plane as the outer circumference of the electrolytic capacitor. This makes it possible to place the cathode leads (4) near a load circuit when the electrolytic capacitor is mounted on a circuit board. Placing the cathode leads (140) near the load circuit shortens an interconnect distance between the cathode leads (140) and the load circuit, resulting in reduction of an equivalent series inductance (ESL) generated between the electrolytic capacitor and the load circuit.

Further, in the aforementioned electrolytic capacitor, a capacitor component is formed between each of the cathode leads (140) and the anode lead (130) of a wound element (110) corresponding to this cathode lead (140). The number of the capacitor components corresponds to the number of the wound elements (110) provided in the electrolytic capacitor, and the capacitor components are connected in parallel. In consideration of an equivalent series inductance (ESL) and an equivalent series resistance (ESR) generated between each of the cathode leads (4) and the anode lead (130) of a wound element (110) corresponding to this cathode lead (140), a capacitor component, an ESL, and an ESR form a series circuit in the electrolytic capacitor. So, the electrolytic capacitor is given an equivalent circuit in which the number of the series circuits corresponds to the number of the wound elements (110), and the series circuits are connected in parallel. As a result, the electrostatic capacitance of the electrolytic capacitor increases in proportion to the number of the wound elements (110), and at the same time, the ESL and the ELR of the electrolytic capacitor are reduced in inverse proportion to the number of the wound elements (110).

As shown in FIG. 8, in the aforementioned electrolytic capacitor, the anode leads (130) of the two wound elements (110) are provided at positions exhibiting rotational symmetry of 180 degrees about the central axis of the electrolytic capacitor, and further, the cathode leads (140) are provided at positions exhibiting rotational symmetry of 180 degrees about the central axis of the electrolytic capacitor. So, even if the electrolytic capacitor to be mounted on a circuit board in a predetermined position is placed on the circuit board in a position rotated 180 degrees from the predetermined position about the central axis of the electrolytic capacitor, the electrolytic capacitor is capable of exhibiting certain electric characteristics.

FIG. 11 is a plan view showing a first modification of the electrolytic capacitor of the second embodiment as viewed from a side opposite the bottom wall (163) of the metal case (160) (see FIG. 7). As shown in FIG. 11, the electrolytic capacitor may include four wound elements (110). In this case, the four wound elements (110) are arranged in a circle along the inner circumference (161) of the metal case (160) as shown in FIG. 11, thereby placing the four wound elements (110) near the inner circumference (161) of the metal case (160). The metal case (160) is given four cathode leads (140) provided in one-to-one relationship with the wound elements (110).

FIG. 12 is a plan view showing a second modification of the electrolytic capacitor of the second embodiment as viewed from a side opposite the bottom wall (163) of the metal case (160) (see FIG. 7). As shown in FIG. 12, the wound bodies (120) of the wound elements (110) may be formed by winding anode foils such that the cross sections of the wound bodies (120) crossing the winding axes thereof are substantially semicircular. The electrolytic capacitor of this modification increases a ratio of the volumes of the wound elements (110) to the capacity of the metal case (160), thereby increasing the electrostatic capacitance per unit volume of the electrolytic capacitor.

In the electrolytic capacitor of the second embodiment, the conductive adhesive agent (170) provided between the inner circumference (161) of the metal case (160) and the outer circumference (113) of the cathode layer (112) of each of the wound elements (110) may not be limited to a position near the opening edge (162), but may extend along the entire outer circumference (113) of the cathode layer (112).

Also, in the electrolytic capacitor of the second embodiment, the pair of cathode leads (140) may be connected to the inner circumference (161) of the metal case (160). In this case, each of the cathode leads (140) is still placed at a position near the outer circumference of the electrolytic capacitor. So, like those of the aforementioned electrolytic capacitor, the cathode leads (140) of the electrolytic capacitor of this case can be placed near a load circuit when this electrolytic capacitor is mounted on a circuit board.

Further, as shown in FIG. 13, the pair of cathode leads (140) may be formed integrally with the metal case (160), more specifically, with the conducting part of the metal case (160).

The structure of each part of the present invention is not limited to that shown in the embodiments described above. Various modifications can be devised without departing from the technical scope recited in claims. By way of example, the electrolytic capacitors of the first and second embodiments may not be given a separator between anode foils forming a wound body.

Further, in the electrolytic capacitors of the first and second embodiments, a metal case may be replaced by a bottomed cylindrical insulating case with a conductive layer at the inner circumference thereof that houses one or a plurality of wound elements. In this case, a cathode lead is electrically connected to the conductive layer.

Reference Signs List
(1) Wound element
(11) Solid electrolyte layer
(12) Cathode layer
(121) Outer circumference of cathode layer
(2) Wound body
(2a) Edge surface
(21) (22) Anode foil
(3) Anode lead
(4) Cathode lead
(6) Metal case (conductive case)
(601) Inner circumference
(7) Conductive adhesive agent (conductive member)
(110) Wound element
(111) Solid electrolyte layer
(112) Cathode layer
(113) Outer circumference of cathode layer
(120) Wound body
(120a) Edge surface
(121) Anode foil
(130) Anode lead
(140) Cathode lead
(160) Metal case (conductive case)
(161) Inner circumference
(170) Conductive adhesive agent (conductive member)

1. An electrolytic capacitor, comprising: a wound body including a wound anode foil with a surface on which a dielectric layer is formed; an electrolyte layer formed inside the wound body and over the outer circumference of the wound body; a cathode layer formed on a surface of the electrolyte layer over the outer circumference of the wound body; a plurality of anode leads electrically connected to the anode foil; and a plurality of cathode leads provided in one-to-one relationship with the anode leads and electrically connected to the cathode layer,
each of the anode leads being pulled out through an edge surface of the wound body, each of the cathode leads being electrically connected to the outer circumference of the cathode layer at a position near an anode lead corresponding to this cathode lead.

2. The electrolytic capacitor according to claim 1, wherein the wound body is formed by winding a plurality of the anode foils, and the anode leads are electrically connected to each of the anode foils at one or a plurality of positions.

3. The electrolytic capacitor according to claim 1, wherein the wound body is formed by winding only one anode foil, and the anode leads are electrically connected to the anode foil at a plurality of positions.

4. The electrolytic capacitor according to claim 1, further comprising a bottomed cylindrical conductive case housing the wound body, wherein conducting part of the conductive case is exposed at least at the inner circumference thereof, a conductive member electrically connecting the conducting part of the conductive case and the cathode layer is placed between the inner circumference of the conductive case and the outer circumference of the cathode layer and at least at a position near each of the anode leads, and the cathode leads are connected to the conducting part of the conductive case to be electrically connected to the outer circumference of the cathode layer through the conductive case and the conductive member.

5. An electrolytic capacitor, comprising:
a plurality of wound elements each having a wound body including a wound anode foil with a surface on which a dielectric layer is formed, an electrolyte layer formed inside the wound body and over the outer circumference of the wound body, a cathode layer formed on a surface of the electrolyte layer over the outer circumference of the wound body, and an anode lead electrically connected to the anode foil and pulled out through an edge surface of the wound body;
a bottomed cylindrical conductive case housing the wound elements; and
a plurality of cathode leads provided in one-to-one relationship with the wound elements, the cathode leads being electrically connected to conducting part of the conductive case,
each of the wound elements being arranged near the inner circumference of the conductive case, each of the cathode leads being placed at a position near a wound element corresponding to this cathode lead,
the conducting part of the conductive case being exposed at least at the inner circumference of the conductive case, a conductive member electrically connecting the conducting part of the conductive case and the cathode layer being placed between the inner circumference of the conductive case and the outer circumference of the cathode layer of each of the wound elements and at least at a position near the anode lead of this wound element.

6. The electrolytic capacitor according to claim 4, wherein the conducting part of the conductive case and the cathode leads are integrally formed.

7. The electrolytic capacitor according to claim 2, further comprising a bottomed cylindrical conductive case housing the wound body, wherein conducting part of the conductive case is exposed at least at the inner circumference thereof, a conductive member electrically connecting the conducting part of the conductive case and the cathode layer is placed between the inner circumference of the conductive case and the outer circumference of the cathode layer and at least at a position near each of the anode leads, and the cathode leads are connected to the conducting part of the conductive case to be electrically connected to the outer circumference of the cathode layer through the conductive case and the conductive member.

8. The electrolytic capacitor according to claim 7, wherein the conducting part of the conductive case and the cathode leads are integrally formed.

9. The electrolytic capacitor according to claim 3, further comprising a bottomed cylindrical conductive case housing the wound body, wherein conducting part of the conductive case is exposed at least at the inner circumference thereof, a conductive member electrically connecting the conducting part of the conductive case and the cathode layer is placed between the inner circumference of the conductive case and the outer circumference of the cathode layer and at least at a position near each of the anode leads, and the cathode leads are connected to the conducting part of the conductive case to be electrically connected to the outer circumference of the cathode layer through the conductive case and the conductive member.

10. The electrolytic capacitor according to claim 9, wherein the conducting part of the conductive case and the cathode leads are integrally formed.

11. The electrolytic capacitor according to claim 5, wherein the conducting part of the conductive case and the cathode leads are integrally formed.
